(19) United States
(12) Patent Application Publication
(10) Pub. No.: US 2015/0125648 A1
(43) Pub. Date: May 7, 2015

(54) INSERT MAT FOR MOTOR VEHICLES FOR PLACING ONTO A WALL-TO-WALL CARPET STRUCTURE OF THE MOTOR VEHICLE

(71) Applicant: Ideal Automotive Oelsnitz GmbH, Oelsnitz (DE)

(72) Inventors: Hubert Röding, Ebrach (DE); Wulf Thoma, Lisberg (DE)

(21) Appl. No.: 14/404,721

(22) PCT Filed: May 29, 2013
(86) PCT No.: PCT/EP2013/061125

§ 371 Date: Dec. 1, 2014

(30) Foreign Application Priority Data
May 30, 2012 (DE) 10 2012 104 656.5

(51) Int. Cl. B60N 3/04

(52) U.S. Cl. CPC B60N 3/046; B60N 3/044; B60N 3/042
USPC 428/90

(57) ABSTRACT

An insert mat for motor vehicles for placing onto a sound-absorbing wall-to-wall carpet structure of the motor vehicle, having an at least three-layer structure, in which the structure has a decorative layer, which is oriented toward the interior of the vehicle in the proper position of the insert mat and is attached to a top surface of a support layer, which surface is oriented toward the interior of the vehicle in the proper position, and a gripping layer, which in the proper position of the insert mat, is attached to a bottom surface of the support layer and is embodied to achieve a hooking interaction with a wall-to-wall carpet of a vehicle, in which the entire structure is embodied to be air permeable, wherein the decorative layer is a tuft, the support layer is a nonwoven, and the gripping layer is a tuft.

### FIELD OF THE INVENTION

The invention relates to an insert mat for motor vehicles for placing onto a sound-absorbing wall-to-wall carpet structure of the motor vehicle, the insert mat having an at least three-layer structure.

### BACKGROUND OF THE INVENTION

DE 41 31 394 A1 has disclosed a sound-insulating material, which is embodied as a composite of at least two layers and at least one of the layers is composed of an air permeable nonwoven; this layer is glued to at least one other component of the composite so that the breathability of the nonwoven is essentially retained. In addition, another layer is in the form of a core layer with walls, which extend essentially vertically—possibly at a slight inclination relative to the layer composed of air permeable nonwoven—and which in their entirety form a multitude of cavities that are open at one end surface. A sound-insulating material of this kind is not suitable for the intended use of the invention. In particular, the fact that the core layer is composed of open cavities makes it impossible for it to be used as an insert mat for motor vehicles since this sound-insulating material is not sufficiently crush-resistant.

US 2005/0075025 A1 has disclosed a carpet structure for use in vehicles, which has a decorative layer, a nonwoven fiber layer as a sound absorption layer, and an adhesive layer that attaches the decorative layer and the sound absorption layer to each other. The adhesive layer is embodied as an air permeable adhesive layer; the adhesive layer is composed of fiber-like adhesive strands that have been melted in an extruder. A carpet structure of this kind is unsuitable for use as an insert mat for placing onto a wall-to-wall carpet structure since it does not have a sufficient adhesion when placed onto an existing motor vehicle carpet. If used as insert mats, carpet structures of this kind would have a tendency to undesirably slip on the carpet structure that is permanently affixed, for example, in the vehicle.

WO 03/045682 A1 has disclosed a porous carpet for vehicles and a method for manufacturing it, in which a tuft-like decorative layer is used. The tuft-like decorative layer has filament arcs that pass in an arc-like fashion through a support layer of the tuft so that there are filament arcs on the back side of the support layer of the tuft. The filament arcs are first held in a closed adhesive layer and fixed in relation to the support layer of the tuft. Then, through the application of vacuum when the adhesive has been softened, fine conduits are produced in the adhesive layer so that a certain breathability of the adhesive layer and thus of the tuft is achieved. For the use as an insert mat, such a breathability has turned out to be insufficient. In addition, the manufacturing method appears to be laborious and not always sufficiently predictable with regard to the number of air conduits per unit area and the uniform distribution of the air conduits produced by the application of vacuum.

In addition, a relatively high quantity of adhesive is required in order on the one hand to fix the filament arcs relative to the support layer of the tuft and on the other hand to fix the filaments of the filament arcs to one another to a sufficient degree.

Based on the above-mentioned prior art, the object of the invention is to disclose an insert mat for motor vehicles for placing onto a sound-absorbing wall-to-wall carpet structure of the motor vehicle, which makes it possible to not impair the sound absorption capacity of the existing sound-absorbing vehicle carpet underneath the insert mat.

In particular, one object of the invention is to be able to embody the insert mat so that it can be permanently deformed, in particular so that it can be permanently deformed as a three-dimensional shaped part.

Another object of the invention, in addition to the sound absorption capacity of the insert mat, is to embody the insert mat to be as impermeable as possible to humidity/moisture.

Another object of the invention is to disclose an insert mat, which can be placed in a particularly non-slip fashion onto an existing wall-to-wall carpet structure of the motor vehicle, preferably without additional fastening means.

### SUMMARY OF THE INVENTION

The object is particularly attained by means of an insert mat for motor vehicles for placing onto a wall-to-wall carpet structure of the motor vehicle, having an at least three-layer structure, in which the structure has:
a decorative layer, which is oriented toward the interior of the vehicle in the proper position of the insert mat
and is attached to a top surface of a support layer, which surface is oriented toward the interior of the vehicle in the proper position, and
a gripping layer, which in the proper position of the insert mat, is attached to a bottom surface of the support layer and is embodied to achieve a hooking interaction with a wall-to-wall carpet of a vehicle,
in which the entire structure is embodied to be air permeable, wherein
the decorative layer is a tuft, the support layer is a nonwoven, and the gripping layer is a tuft.

Conventional, previously used structural bases for floor mats were composed of five layers; floor mats of this kind, when they should have the capacity to be shaped and thus brought into a particular shape and should have the capacity to be inserted in a precisely fitting fashion into a floor contour of a vehicle, have two thick adhesive layers between a decorative layer and nonwoven middle layer on the one hand and a gripping layer and the same middle layer on the other. These thick adhesive layers have masses per unit area of significantly greater than 300 g/m² and are composed of a thermoplastic adhesive, which performs not only a bonding function but also a stabilizing function and ensures the capacity to be shaped. Previously used nonwovens were so-called nonwoven mats with masses per unit area of 80 g/m² to 200 g/m² and thicknesses of 1 mm to 2 mm.

Such previously known floor mat structures could be manufactured in an endless production, but had no breathability or only very slight breathability. With materials of this kind according to the prior art, when this material is placed as a floor mat onto a wall-to-wall carpet structure that performs a sound-absorbing function in a motor vehicle, this significantly impairs the latter's sound-absorbing function.

The invention now makes it possible to produce a highly air permeable material, which is nevertheless deformable and also retains a shape. This material is air permeable enough that in tests, a candle could be blown out through the material, while the tested material was at the same time nevertheless impermeable to water.

These intrinsically conflicting properties are achieved due to the fact that for the nonwoven middle layer, a nonwoven is used that was previously unknown for such applications and is actually used for garments in the textile industry. This nonwoven has a thickness of up to 2 mm with a mass per unit area of 200 g/m² to 450 g/m², in particular 220 g/m² to 260 g/m². This nonwoven contains 15% to 25% adhesive fibers, in particular 20% adhesive fibers. The breathability is between 2000 l/m²/s and 3500 l/m²/s with a pressure difference of 200 Pa. The nonwoven middle layer is composed, for example, of a PET nonwoven—and/or a natural fiber nonwoven.

Since this nonwoven middle layer alone already has a good shaping behavior, both the outer decorative layer and the gripping layer on the bottom can be bonded to the nonwoven middle layer with a relatively thin adhesive layer; adhesive masses of 150 g/m² are already sufficient. With such a mass per unit area of adhesive, this adhesive layer cannot fulfill a shaping function. In addition, these adhesive layers are not applied to the entire area. On the whole, this results in an overall mass of the structure according to the invention of approximately 480 g/m² to 550 g/m² as compared to more than 700 g/m² in known structures.

The adhesive between the nonwoven middle layer and the decorative layer on the one hand and the gripping layer on the other can be a heat-activated adhesive; it can, however, also be a two-component adhesive. If a two-component adhesive is used, this changes the workability of the overall composite.

If heat-activated adhesives must be used, then corresponding preforms must be cut out from the nonwoven middle layer as well as from the decorative layer and the gripping layer; the adhesive is applied to the respective back side with the hollow nubs of both the gripping layer and the decorative layer, which are both embodied as tufts. These layers, which are thus already provided with adhesive, are placed—together with the nonwoven middle layer in a correctly positioned, aligned orientation—into a forming tool, then heated and shaped. On the one hand, this produces the composite and on the other hand, it achieves the corresponding stable shape.

If a two-part adhesive is used for bonding the layers to each other, then the material can be supplied as a rolled product since a bond of the layers of the composite to one another already exists, which is independent of heat. Then preforms can be stamped out from this rolled product ahead of time and placed into a shaping tool.

In one embodiment, the adhesive is selected with regard to the quantity of filament arcs and with regard to its viscosity during the production of the insert mat so that the filament arcs are fixed in relation to a support layer of the decorative carpet and a support layer of the gripping layer and the filament arcs are glued to the support layer of the insert mat not over the entire surface, but in a partial, in particular point-by-point/linear fashion and the majority of the filaments of a filament arc are fixed to one another by means of the adhesive.

The filament arcs can be advantageously fixed in relation to the support layer exclusively by means of the adhesive with no other fixing provided, e.g. in the form of a latex layer.

In addition, in another advantageous embodiment, there are open nub channels that are free of adhesive situated between the nub-like filament arcs.

It is also advantageous if, during the manufacture of the insert mat, the adhesive is applied by means of an adhesive roller to the filament arcs, in particular to the zeniths of the filament arcs.

The adhesive is advantageously embodied in the form of a thermoplastic adhesive.

It is also advantageous if the support layer (nonwoven middle layer) of the insert mat is an air permeable support nonwoven with a hydrophobic finish.

It is also advantageous if the decorative layer is an Econyl® recycled nylon, high-pile tuft with a mass per unit area of 860 g/m².

It is also advantageous if the hooking layer is a non-slip tuft with a mass per unit area of 400 g/m².

The hydrophobic finish of the support layer is advantageously able to withstand a pressure of 50 mm to 60 mm of a water column.

It is also advantageous if the support layer is a thermally solidified nonwoven with a maximum thermally active fiber content of 20%.

It is also advantageous if 100% to 20% of the fibers of the support nonwoven that constitutes the support layer are thermally activated fibers.

The insert mat is advantageously composed of two intermediate products; the first intermediate product is composed of the decorative layer, the support layer, and the adhesive between the decorative layer and support layer, the second intermediate product is composed of the gripping layer, which has the adhesive at the zeniths of the filament arcs; and the first intermediate product and second intermediate product are attached to each other in a heatable press, particularly in a forming tool.

On a free outer surface of the gripping layer, gripping or hooking means are also provided in some areas and are for cooperating, for example, with a gripping or hooking partner of the wall-to-wall vehicle carpet structure.

### BRIEF DESCRIPTION OF THE DRAWINGS

The invention will be explained in greater detail below by way of example in conjunction with the drawings. In the drawings:

FIG. 1: schematically depicts a cross section through a layer structure of an insert mat according to the invention;

FIG. 2: is a schematic, more detailed depiction of the layer structure of the embodiment according to FIG. 1 with a glue line;

FIG. 3: is a view of filament arcs of tuft materials, which are used as a decorative layer and/or as a gripping layer and are provided with adhesive;

FIG. 4: schematically depicts a graph in which the equivalent absorption area is plotted over the frequency, with measurement curves of a floor covering (wall-to-wall carpet structure) of the motor vehicle alone, of the insert mat according to the invention alone, and of a composite made up of the floor covering/wall-to-wall carpet structure and the insert mat according to the invention, as well as a target curve of the absorption.

### DETAILED DESCRIPTION OF THE PREFERRED EMBODIMENTS

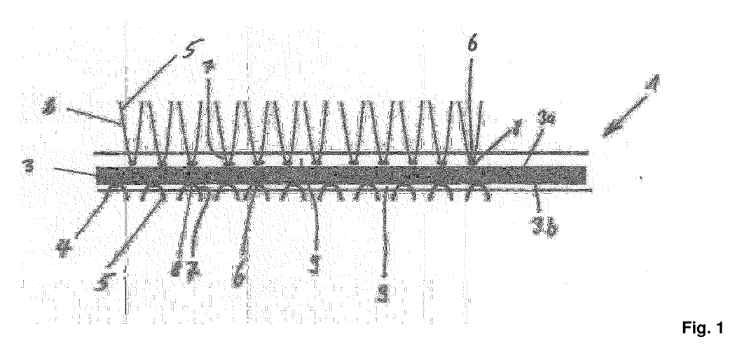

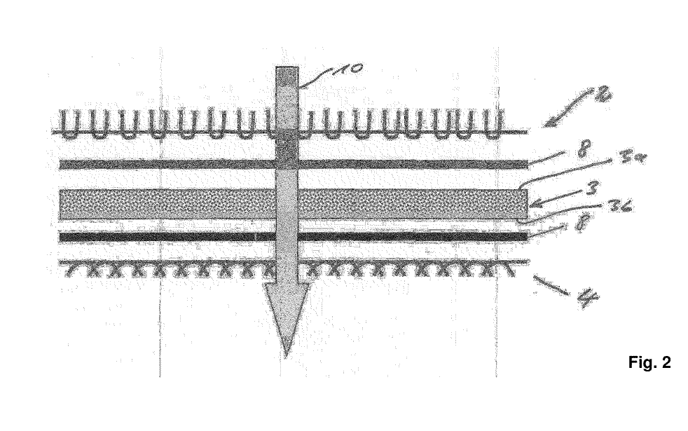

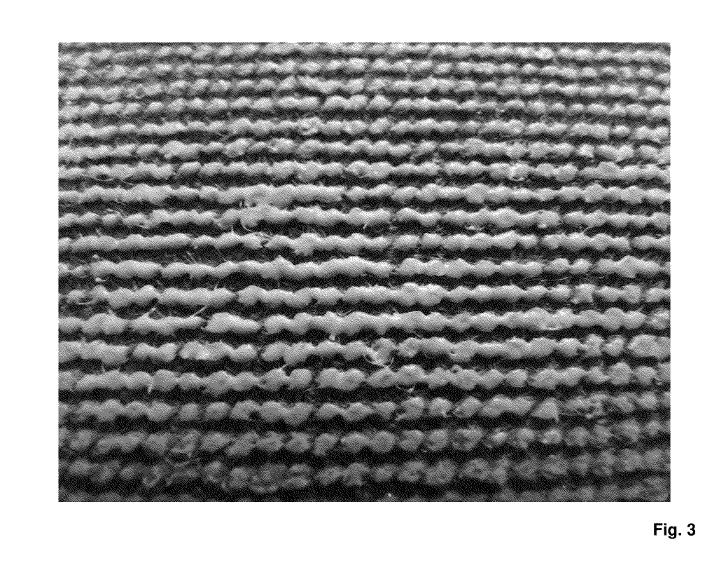

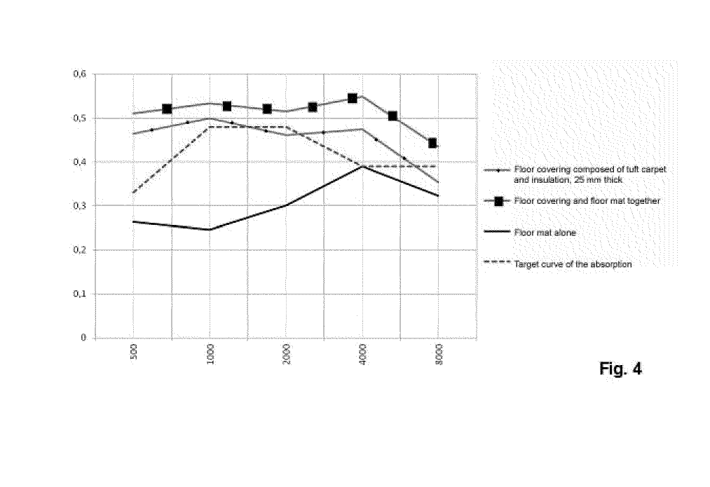

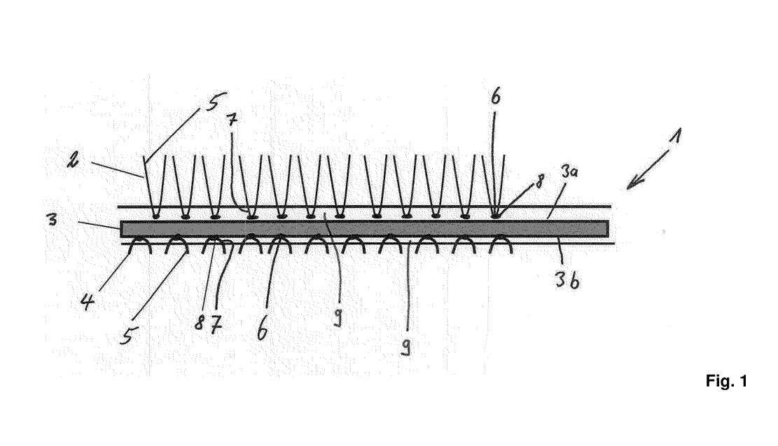

A cross-sectional view of the layer structure of an insert mat according to the invention is particularly visible in FIG. 1. The insert mat according to the invention is basically provided to be used in addition to a carpet that is already present in the vehicle or is provided in a corresponding textile coating.

In particular, this is the usual sound-absorbing wall-to-wall carpet structure that is present in the vehicle.

Basically, the insert mat 1 according to the invention has an essentially three-layered structure, which includes a decorative layer 2. A decorative layer 2 of this kind is oriented toward a vehicle interior. There is also a support layer 3 and a gripping layer 4, which, when properly positioned, is oriented toward a vehicle floor or a wall-to-wall carpet structure of a vehicle.

The support layer 3 has a top surface 3a and a bottom surface 3b so that the top surface 3a is oriented toward the decorative layer 2 and the bottom surface 3b is oriented toward the gripping layer 4.

The decorative layer 2 is embodied as a so-called tuft. A tuft is a textile material in which needles insert the so-called pile yarn into a base material such as a woven or nonwoven (the so-called primary backing). This produces so-called pile nubs 5, i.e. loops, on the top surface of the tufting woven or nonwoven. The loops can be cut with a knife to produce a velvet carpet or cut-pile carpet. For example, the decorative layer is an Econyl® recycled nylon, high-pile tuft.

The support layer 3 is embodied as a nonwoven; the gripping layer 4 is also embodied as a tuft. Both the decorative layer 2 and the gripping layer 3 have pile loops 5; the pile loops 5 have nub-like filament arcs 7 on the side oriented toward the support layer 3; the nub-like filament arcs 7 form zeniths 6 and the zeniths 6 of the filament arcs 7 are oriented toward the support layer 3.

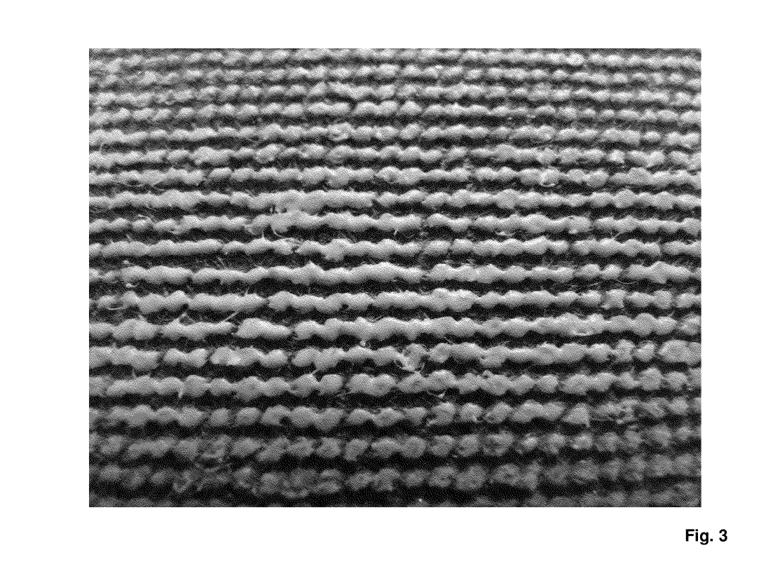

For the fastening of the decorative layer 2 and/or of the gripping layer 4, an adhesive 8 is applied to the zeniths 6 in a point-by-point or linear fashion. A linear arrangement can also be produced by virtue of the fact that point-by-point applied adhesive 8 of adjacent zeniths 6 runs together. As can be seen in FIG. 3, this produces tracks or lines of adhesive extending along the zeniths 6, while nub channels 9, which are free of adhesive, remain open between them.

The adhesive 8 is in particular applied to the filament arcs 7 or the zeniths 6 of the filament arcs 7 by means of an adhesive roller. In this connection, the adhesive 8 can, for example, be a thermoplastic adhesive, but can also be any other adhesive.

The support layer 3 is a woven, a knit, a felt, or a nonwoven, where the support layer 3 is embodied as air permeable. In addition, the support layer 3 can have a hydrophobic finish; the hydrophobic finish, however, must fulfill the requirement that it does not significantly influence the breathability.

The decorative layer is in particular a high-pile tuft with a mass per unit area of 350 g/m² to 860 g/m².

For example, the support nonwoven of the support layer 3 is a PET nonwoven and/or a natural fiber nonwoven with a mass per unit area of 220 g/m² to 450 g/m².

For example, the gripping layer 4 is a non-slip tuft with a mass per unit area 300 g/m² to 500 g/m².

The adhesive 8 is applied to the zeniths 6 in a quantity of 80 g/m² to 300 g/m² per adhesive layer.

The hydrophobic finish of the support layer 3 is preferably embodied so that it is able to withstand a pressure of 50 mm to 60 mm of a water column so that even though the decorative layer 2 can in fact be thoroughly soaked, no water penetrates through the support layer 3 to a wall-to-wall carpet of the vehicle. The applied liquid on the decorative layer 2 can then dry.

The nonwoven of the support layer 3 is preferably a PET nonwoven 15% to 25%, in particular 20% of the fibers of the support nonwoven constituting the support layer 3 are thermally activated adhesive fibers.

The insert mat 1 according to the invention in this case can be manufactured out of two intermediate products; the first intermediate product is composed of the decorative layer 2, the support layer 3, and the adhesive 8 between the decorative layer 2 and the support layer 3.

The second intermediate product is composed of the gripping layer 4, which has the adhesive 8 at the zeniths 6 of the filament arcs 7.

The two intermediate products are placed together into a heatable press and are attached to each other therein by means of pressing and heating; it is particularly advantageous if both the adhesive and the nonwoven can be thermally activated. In this case, the pressing can preferably occur in that the intermediate products are already cut to the required dimensions and are placed into the press in a correspondingly congruent fashion and are then attached to each other.

Preferably, additional gripping or hooking means for cooperating, for example, with a gripping or hooking partner in the wall-to-wall vehicle carpet structure can be provided on the free outside of the gripping layer 4.

To this end, it is also possible to give the insert mat a predetermined shape that is adapted to the vehicle body.

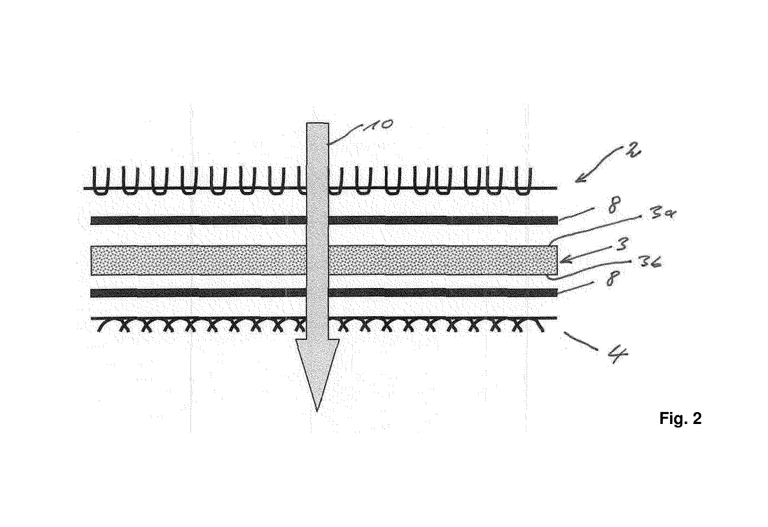

FIG. 2 once again shows the air permeable structure of an insert mat 1 according to the invention for an optimal acoustic absorption, showing the decorative layer 2, which is embodied, for example, in the form of a high-pile tuft, a first adhesive layer 8, which is shown in the form of a line and bonds the zeniths 6 of the filament arcs 7 to one another, and then the support layer 3 with a support layer top surface 3a and a support layer bottom surface 3b, a second adhesive layer 8 between the support layer 3 and the gripping layer 4, which is in particular a non-slip tuft.

The arrow 10 indicates the through-flow direction.

As explained above, FIG. 3 shows the adhesive 8, which is not applied over the entire area, but rather to the zeniths 6 of the filament arcs 7 and which has partially run, forming the corresponding adhesive lines, but lies on some of the nubs singly. The nub channels 9 between them, which do not hinder the flow from traveling through, are clearly visible.

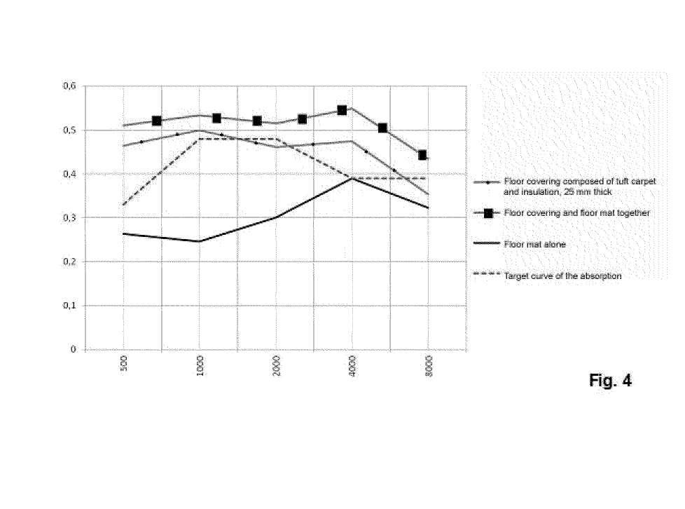

FIG. 4 shows various absorption curves of the sound absorption of a floor mat, measured in an Alpha cabinet according to the testing recommendations of the automobile manufacturer.

On the one hand, this figure shows the target curve of the absorption and in contrast with this, the absorption curve of a floor mat according to the invention alone. The figure also shows the floor covering composed of the tufted carpet and an insulation with a thickness of 25 mm, corresponding to the wall-to-wall carpet structure in motor vehicles.

Above this appears the improved sound absorption achieved by the combination of a floor covering and the floor mat according to the invention.

The air permeable floor mat according to the invention has the advantage that an insert mat is inexpensively produced, which can be placed onto an existing wall-to-wall carpet structure of the motor vehicle in a non-slip fashion without additional fastening means and which, together with the wall-to-wall carpet structure, achieves a higher absorption coefficient.

1. An insert mat for motor vehicles for placing onto a sound-absorbing wall-to-wall carpet structure of the motor vehicle, having an at least three-layer structure, in which the insert mat structure comprises:
a decorative layer, which is oriented toward an interior of a vehicle in a proper position of the insert mat,
a support layer, wherein the decorative layer is attached to a top surface of the support layer, and the top surface is oriented toward the interior of the vehicle in the proper position, and
a gripping layer which in the proper position of the insert mat, is attached to a bottom surface of the support layer and is embodied to achieve a hooking interaction with a wall-to-wall carpet of a vehicle,
in which the entire structure is air permeable, wherein
the decorative layer is a tuft, the support layer is a nonwoven, and the gripping layer is a tuft,
the tufts of the decorative layer and the gripping layer each have pile loops inserted into a primary backing, wherein the pile loops have zeniths facing the support layer, and
an air permeable connection of the decorative layer is produced at the top surface of the support layer and an air permeable connection of the gripping layer is produced at the bottom surface of the support layer by an adhesive applied on the zeniths in a point-like or line-like manner.

2. The insert mat according to claim 1, wherein the adhesive is a thermoplastic adhesive.

3. The insert mat according to claim 1, wherein the support layer of the insert mat is an air permeable support nonwoven with a hydrophobic finish.

4. The insert mat according to claim 1, wherein the decorative layer is a high-pile tuft with a mass per unit area of 305 g/m² to 860 g/m².

5. The insert mat according to claim 1, wherein the support nonwoven of the support layer is a PET nonwoven or a natural nonwoven with a mass per unit area of 200 g/m² to 450 g/m².

6. The insert mat according to claim 1, wherein the gripping layer is a non-slip tuft with a mass per unit area of 300 g/m² to 500 g/m².

7. The insert mat according to claim 1, wherein the adhesive is applied in a quantity of 80 g/m² to 300 g/m² per adhesive layer.

8. The insert mat according to claim 1, wherein the hydrophobic finish of the support layer withstands a pressure of at least 50 mm of a water column.

9. The insert mat according to claim 1, wherein at least 20% of the fibers of the support nonwoven that constitutes the support layer are thermally activated adhesive fibers.

10. The insert mat according to claim 1, wherein the insert mat is manufactured out of two intermediate products; a first intermediate product is composed of the decorative layer, the support layer, and the adhesive between the decorative layer and the support layer, a second intermediate product is composed of the gripping layer, which has the adhesive at the zeniths of filament arcs, and the first intermediate product and the second intermediate product are attached to each other after a thermal activation in a device using a forming tool.

11. The insert mat according to claim 1, wherein on a free outer surface of the gripping layer, gripping or hooking devices for cooperating, for example, with a gripping or hooking partner of the wall-to-wall vehicle carpet structure are also provided in some regions.
